(19) United States
(12) Patent Application Publication
(10) Pub. No.: US 2002/0077180 A1
(43) Pub. Date: Jun. 20, 2002

(54) To interactive computer games

(76) Inventors: Arthur Swanberg, Westport, CT (US); Ethan Rappaport, Orange, CT (US)

Correspondence Address: George R. Pettit, Pollock, Vande Sande & Amernick, R.L.L.P., P.O. Box 19088, Washington, DC, 20036-0088, US

(21) Appl. No.: 09/737,772

(22) Filed: Dec. 18, 2000

(51) Int. Cl. A63F 13/00

(52) U.S. Cl. 463/43

(57) ABSTRACT

A computer implemented game which uses a smart card for obtaining additional game features. The computer software running on the computing system includes a portion of code which is generally locked from use. The locked portion of code represents additional characters, levels of play, and other game playing enhancements which may be played in the game. Unlocking of the code set occurs when a user has the appropriate smart card representing the character. Alternatively, the game playing computer software may receive installable code from the smart card which defines additional characters for level of play for the user.

### RELATED PATENT APPLICATIONS

U.S. patent application Ser. No. 09/472,042

### BACKGROUND OF THE INVENTION

The present invention relates to computer implemented interactive games which derive at least a portion of their game functions from an external smart card. Specifically, a system is disclosed which permits external smart cards to be used for increasing the game functionality.

Computer implemented games are increasingly popular. Early versions of these games permit a user to play a game where the player skill is matched against the game rules. It has been proposed in the related U.S. patent application, hereby incorporated by reference, to permit games to be played which are based on purchasable trading cards in the form of a smart card. Smart cards are provided in two versions. The first version is a microprocessor based circuit embedded in a small card which is currently used in various banking applications. Users can exchange credit and debit information with a central banking location as part of the process for transferring funds into and out of a bank account. The second version is a memory based circuit embedded in a small card containing security features which are currently used in prepaid telephone applications.

In accordance with the related patent application, it has been proposed to use the smart card as a trading card which contains information necessary to play a game on a computer. The game information is read through a reader connected to a personal computing system. Additional trading cards may be collected, where the games functionality is increased or changed depending on the new trading card. In a character based game, additional characters for playing the game may be acquired by purchasing additional trading cards.

The foregoing system can be either locally based or an internet based system. With the internet based game system, the game is played with information derived from a website controlled by the trading card vendor. In a sports game, it is possible to acquire individual team members by obtaining additional trading cards pertaining to a particular personality. Each new trading card will result in a new player being added to the game until the user has assembled a full team. Scoring depends on the relative statistics of each team member.

The use of the smart trading card provides still other advantages in computer game execution. The present invention is directed to further improvements to computer game programs using the smart trading card.

### SUMMARY OF INVENTION

A computer implemented game is provided wherein game software running on the computer accesses an external smart card to obtain data related to one of the characters in the game or a portion of game play. The data read from the smart card unlocks executable code in the computer program relating to the character or portion of game play. Alternatively, or additionally, the smart card can provide installable code for the computer game, including image files, audio files or attributes pertaining to the character or portion of game play.

The smart card may also enhance the use of the card in an internet based game. When a game is to be played using information obtained from a website as part of the game, the smart card may be read by the local computer system executing the game playing computer code to obtain an electronic address. The electronic address is used by the computing system browser software to automatically access the appropriate website.

Still other objects and advantages of the present invention will become readily apparent by those skilled in the art from the following detailed description, wherein it is shown and described in preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### DESCRIPTION OF THE FIGURES

FIG. 1 illustrates a computing system for playing a computer implemented game;

FIG. 2 illustrates the layout of characters which are displayed on monitor 12 while playing the computer game;

FIG. 3 illustrates the computer programming steps executed by the computing system for increasing game functionality based on smart card data;

FIG. 4 illustrates an internet based computer game which uses smart card information to locate the appropriate website for playing a game.

FIG. 5 illustrates the computer programming steps executed by the computing system of FIG. 4.

### DESCRIPTION OF THE PREFERRED EMBODIMENT

Referring now to FIG. 1, a computing system for playing computer implemented games is shown. The computing system may be a standard personal computer having a keyboard 10, processor 9 and a monitor 12. Game software is loaded into the computer 9 memory from a disk 8 which may be a CD-ROM, floppy disk or game cartridge containing game software. Alternatively, a computer game console for playing computer implanted games may be used instead of a personal computer which typically would not include a keyboard or mouse/pointer device. As used herein, computing system means either type of game playing hardwaves and any equivalent thereof. The computer processor 9 operates in response to commands from the keyboard 10 or from point and click controls provided by the pointing device or mouse 16. Computer 9 is also connected via a serial port or USB port 17 to an internet connection 16, permitting the game software to be played in conjunction with a website maintained by the game software vendor.

The computing system of FIG. 1 also includes a smart card reader 11 which receives a smart card 10 containing data related to the game software being executed on the computing system. The reader is an existing smart card reader, such as the ACR cybermouse, GEM+GCR410, or another well-known readers. The reader may be connected to a USB port or a serial (COM) port combined with either the keyboard port, or mouse port of the processor 9. The reader has the ability to read and write information to the smart card 10 using the standard protocol associated with smart card.

The smart card 10 serves as a trading card for hobbyists who play the computer game. In accordance with one embodiment of the invention, the smart card may contain data finding a character to be added to the game. Printed on the smart card 10 may be a picture 15 identifying the character, along with some basic information concerning the character. The smart card 10 contains information stored in its memory which will be accessed by the processor 9 while executing the game software 8.

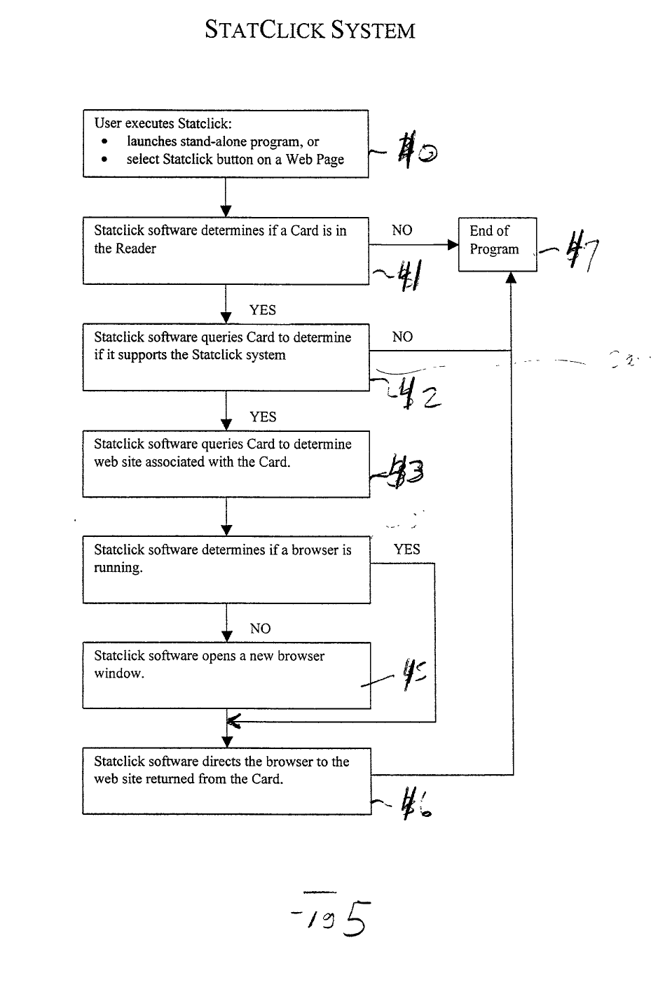

The addition of characters, new game portions, or cheat codes to the game being played can be based on one of two techniques which requires data to be read from the smart card 10. In the first, which will be explained in greater detail with respect to FIG. 4, data is stored in the memory which unlocks the section of code in the game software 8, permitting access to all of the information necessary to add the character to the game. The unlock code may be a special byte sequence which is recognized by the computing system executing the game software. The disadvantage of this feature is that it requires knowledge of all future characters in advance of issuing any smart trading cards 10, as all characters would necessarily have to be provided on a restrictive basis in the code of the game software 8 before the software 8 is issued to the user.

As another approach to be explained in greater detail, the game software is written open-ended, so that characters may be installed from code stored in the smart trading card 10 permitting new characters to be added at any time in the future.

In implementing the unlock key for accessing code dedicated to a specific character represented by the smart trading card 10, some of the character abilities and levels of game play may also be contained in the code which is to be unlocked. Thus, the game software 8 when reading the smart card 10 will make the character and a particular level of game play available for the user.

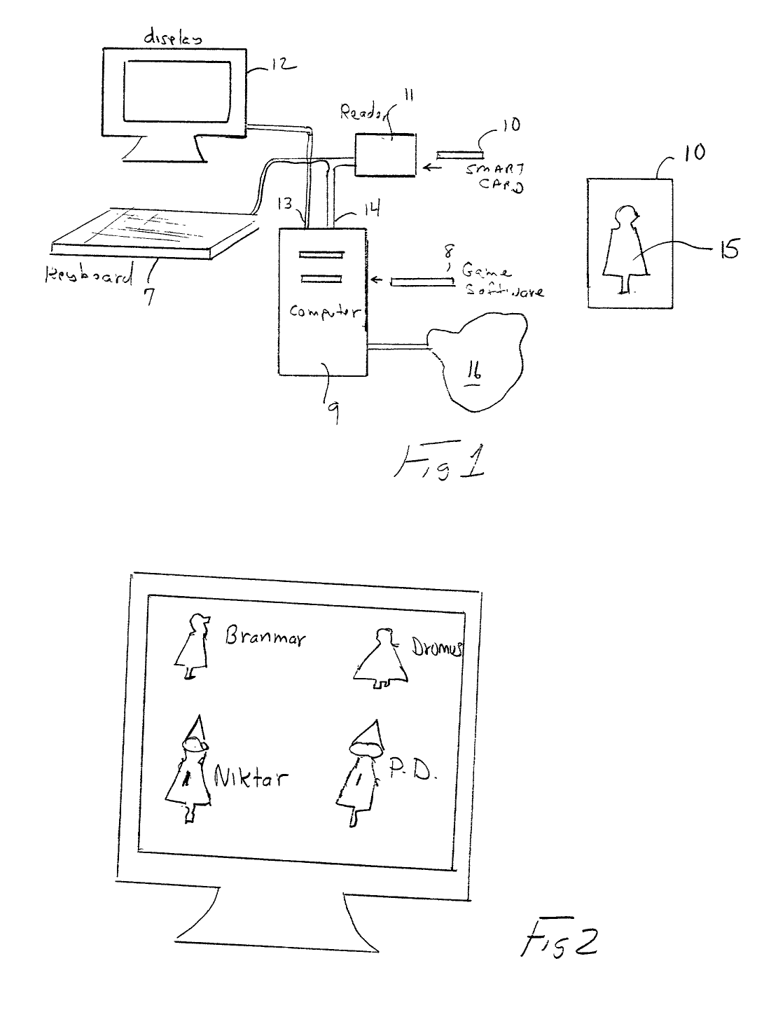

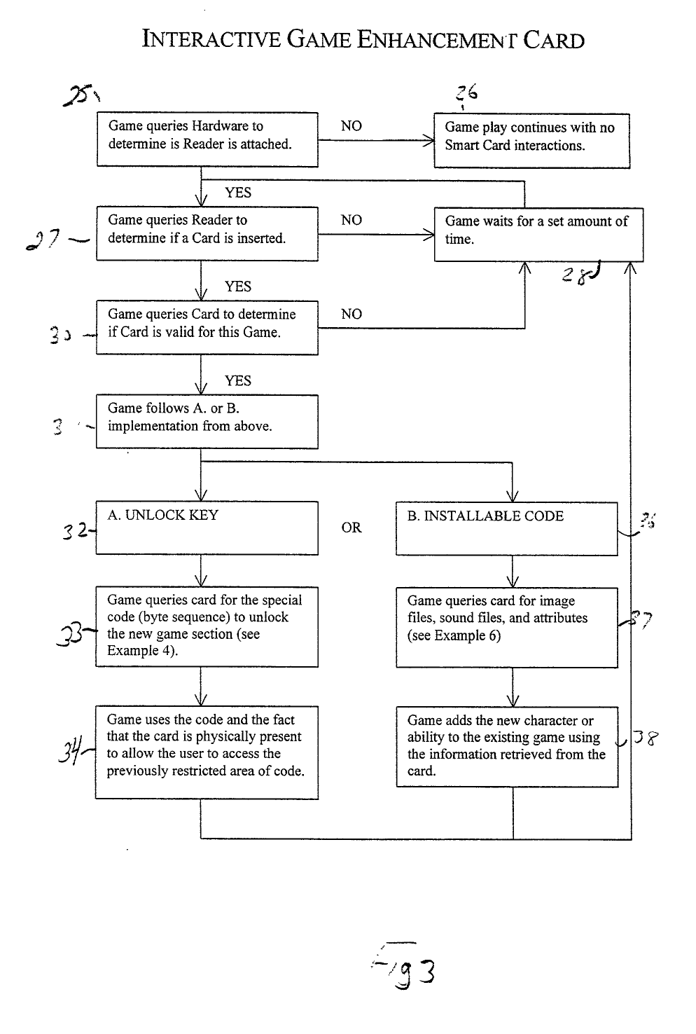

FIG. 2 illustrates the role playing game of Wizard's Battle Game wherein several different wizards, identified as Branmar, Niktar, and Dromus, and one practice dummy, are displayed on the monitor 12. Each of the characters can only be displayed when a corresponding smart trading card 10 has been inserted in reader 11, and read during execution of the game software 8. The picture appearing on the display monitor 12 may be identical to that shown on the smart trading card 10. Additionally, each of the smart trading cards 10 includes the name of the wizard.

The smart card 10 may, instead of providing an unlocking code through the game software 8, include new installable code that interacts with existing code of the game software 8 to add a new character, or ability, to an existing character. For example, in a role playing game being played on the computer system 9, the game software 8 during execution will read the contents of the smart trading card 10 through other reader 11, and use the code obtained including image files, sound files, character actions and abilities to introduce a new area of game play to the existing game. In the wizards game, several images such as an adult body, a child body, an adult arm up and an adult arm down, a child arm up, a child arm down, and a full wizard view will be downloaded from the smart trading card 10. The wizards as part of the game scheme have basic spells they can cast. A spell includes the name of the spell, two magic words to cast the spell, and an image of an animal representing that the spell that has been cast. Additionally, a score necessary to have the wizard mature to adulthood can be loaded from the smart trading card 10.

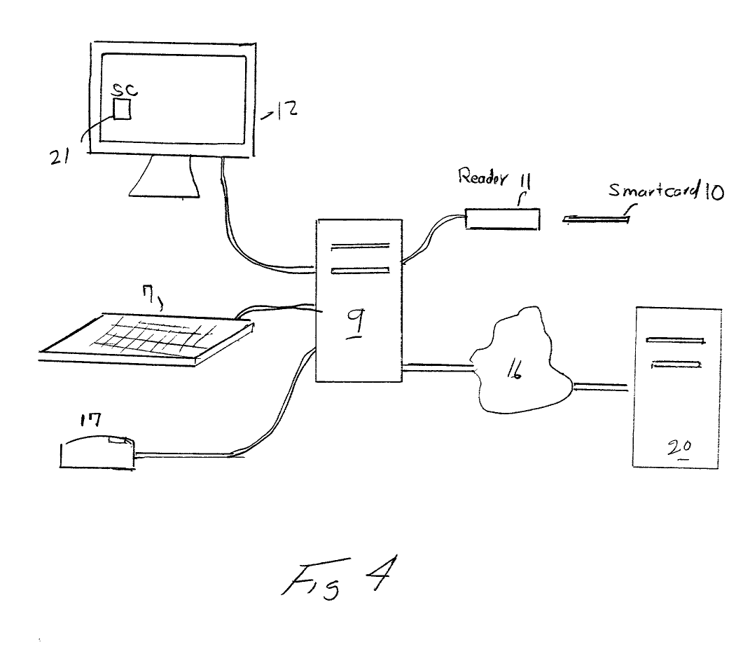

The execution sequence by the processor 9 executing the code contained in the game software 8 is illustrated more specifically in FIG. 3.

Referring now to FIG. 3, the process executed by the processor 9 is shown. As part of the executable code sequence for the game software 8, the software execution queries whether or not the reader is attached to a port of processor 9 in step 25. In the event there has been no reader detected, a game play continues in step 26 without the benefit of any smart card data.

If a reader is connected, the reader is again queried in step 27 to determine if a smart card is present. If not, the system waits a period of time 28 and periodically inquires as to whether the reader and card are available for reading.

The game software execution sequence queries the smart trading card in step 30 to determine if the card is valid for the game being played. If the card is valid, the execution sequence follows one of two paths, A or B, depending on the determination of which type of implementation has been used.

In the event that the card contains an unlock key as determined in step 32, the executed code of the game software queries the card for the unlock code in step 33 to unlock a section of code contained in a computer game program 8. The unlock code is then used by the game program 8 to permit access to previously restricted areas of code contained in the game program 8.

In the event that the invention is implemented using installable codes, as determined in step 36, the execution of the game software results in the smart card being queried for image files, sound files, and any attributes which are associated with a player or character in the game in step 37. The new information relating to game is stored in a RAM of the processor 9 in step 38, and is used to play the game using this information.

Thus, it can be seen that by using the outside smart card, stand alone computer implemented games may be played and additional features used depending on the user's possession of a given smart card. Additional smart cards may be collected and used to make the game more interesting to the user.

FIG. 4 illustrates the use of the smart card for enhancing the operation of a computer implemented game which relies upon accessing a remote computer via a network 19. The computer implemented game is played on a computing system comprising a processor 9, monitor 12, input devices 7 (keyboard) and 17 (pointing device/mouse). Additionally, a card reader 11 is connected to a COM port or USB port of the processor 9 for reading a smart card 10. In order to play the interactive game, software is executed by processor 9. Other code such as a browser plug in, necessary for playing the game resides on a remote server 20 as part of a website maintained by the game vendor. The additional code is retrieved via a network connection 17 to a network 16, such as the internet, and downloaded to the internal memory of computing system 9.

In order to initiate a session with the manufacturer's remote terminal, which may be a website running on remote server 20, the user selects an icon 24 displayed by the graphical interface of the computing system using the pointing device/mouse 16. As will now be explained in greater detail with respect to FIG. 6, selection of the icon 21 using the point and click feature of the graphical interface initiates a connection between a browser application running on the computer 9 and the server 20 application containing the manufacturer's website.

The game software 8 begins execution in step 40 by clicking on the icon 24 presented from the game software 8. The code contained in the game software determines in step 41 if a smart card 10 is in the reader 11. If the card returns an indication that it supports the software 8, in step 42 the software 8 determines a remote computer application location, such as a website address, from reading data on the smart card in step 43. The executed game program code determines in step 44 if the browser application of the computing system is running. If not, the computer software execution opens the browser application in step 45. The continued execution of the game software 8 results in the browser accessing the website using the website address retrieved from the smart card 11 in step 46. Once the website is acquired, the instruction set is completed in step 47.

While the foregoing implementation is directed to enhance game playing using an internet connection, the system may have other non-game applications, where users gain access to other products and services using the foregoing invention. For instance, users can be directed to other websites unrelated to playing a game.

The foregoing executable code may be initially downloaded from a manufacturer's website, to the hard disk of the computer processor 9. Additionally, the software may be available as a browser plug in-in, for the particular browser application run on the computing system processor 9.

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A computer implemented game comprising:
computing system for playing a computer game;
a game playing computer program stored in said computing system, said game program including interactive characters representing participants in a contest;
a smart card reader connected to said computing system which is periodically queried to determine the presence of a smart card; and
a smart card having stored therein data pertaining to a feature of a game being played; said smart card data being read by said game playing software which enables said game to be played.

2. The computer implemented game according to claim 1 wherein said smart card data is used in said computing system to unlock executable code in said computer program which permits said feature of the game to be played.

3. The computer implemented game according to claim 1 wherein said smart card data provides installable code for said computing system which permits said feature of the game to be played with said one character.

4. The computer implemented game according to claim 2 wherein said smart card data for unlocking said executable code is a special byte sequence recognized by said computer system running said game program whereby previously unaccessible game program executable code is run with said game program.

5. The computer implemented game according to claim 3 wherein said installable code includes image files for representing a character.

6. The computer implemented game according to claim 3 wherein said installable code includes attributes pertaining to a game character.

7. The computer implemented game according to claim 3 wherein said installable code constitutes a sound file relating to a game character.

8. The computer implemented game according to claim 1 wherein said computing system under control of said program interrogates said card reader to verify the connection of said card reader to said computing systems.

9. The computer implemented game according to claim 1 wherein said computing system recovers data from said smart card which r epresents a game playing level of said character.

10. The computer implemented game according to claim 1 wherein said smart card provides said game playing program with additional playing features for said game.

11. A computer implemented game comprising:
a smart card containing an electronic address of a remote computing system containing computer code necessary for playing a computer game;
a smart card reader for receiving said smart card; and
a computer system connected to said smart card reader, said computer system having stored therein computer code for playing a game, said computer system executing said game playing computer code in response to a user selection made through a graphical interface of said computer system, said computer code including instructions for obtaining the electronic address from said smart card of a remote computer containing related game playing computer code; said computer system including a browser application responsive to said user selection for accessing said remote computer using said electronic address.

12. The computer implemented game according to claim 11 wherein said computer code determines if said smart card is in said reader before attempting to read said smart card.

13. The computer implemented game according to claim 11 wherein said computer code constitutes a browser plug in which is activated through said graphical interface to read said address from said smart card.

14. The computer implemented game according to claim 13 wherein said browser plug in is stored on a web site operated by a manufacturer of said game and is downloaded from said web site to said computer system.
